(19) United States
(12) Patent Application Publication
(10) Pub. No.: US 2024/0219878 A1
(43) Pub. Date: Jul. 4, 2024

(54) Valve Control Device

(71) Applicant: GEA Tuchenhagen GmbH, Büchen (DE)

(72) Inventors: Heiko Stender, Lübeck (DE); Konstantin Buchmann, Hamburg (DE)

(21) Appl. No.: 18/557,783

(22) PCT Filed: Apr. 26, 2022
(86) PCT No.: PCT/EP2022/061037

§ 371 Date: Oct. 27, 2023

(30) Foreign Application Priority Data
Apr. 30, 2021 (DE) 10 2021 002 287.4

(51) Int. Cl. G05B 19/042

(52) U.S. Cl. CPC G05B 19/0423; G05B 2219/25127; G05B 2219/25221; G05B 2219/25312

(57) ABSTRACT

A valve control device with a switching stage, control electronics for controlling the switching stage, and a bus interface for communicating with a system controller of a processing plant is described. A near-field communication interface is provided in the valve control device, and the control electronics are configured to give a control command coming in through the near-field communication interface priority for controlling the switching stage. A method for operating an arrangement with a valve control device comprises a first near-field communication interface and a bus interface, and an access device with a second near-field communication interface. A near-field connection is established between the first and the second near-field communication interface, a control command is sent over the near-field connection, and the control command is given priority over a command received by the valve control device through the bus interface.

### TECHNICAL FIELD

The invention relates to a valve control device comprising a switching stage, control electronics for controlling the switching stage, and a bus interface for communicating with a system controller of a processing plant and to a method for operating an arrangement with a valve control device comprising a first near-field communication interface and a bus interface, and an access device with a second near-field communication interface.

### BACKGROUND

Valves are used in systems for the production of food products, beverages, medicines, and fine chemical products, as well as in biotechnology. Due to the size of such systems and the degree of automation, the valves are often equipped with valve control devices that are attached to them.

A combination of a valve and a valve control device is presented in International Patent Publication No. WO 2006/084541 A1. The valve control device ensures that the valve state switches, for example, between the states “open,” in which a flow of fluid through the valve is enabled, or “closed,” in which the flow of fluid is prevented.

The valve control device controls the often, but not necessarily, pneumatically designed drive. For this control, at least one of what is known as a pilot valve is provided, which can let pneumatic air flow into the drive to activate it and thus to change the switching state of the valve.

In addition to this switching function, the valve control device is equipped with a sensor system that allows it to determine the switching state of the valve.

The valve control device has a communication interface in order to receive control commands, for example, through a bus of a system controller and to report the switching state to it. For this purpose, International Patent Publication No. WO 2006/084541 A1 describes a favorable structure for providing various bus standards.

The use of near-field communication interfaces in conjunction with field devices, for example, valve control devices, is more recent. Near-field communication is used to communicate directly, or in the case of a poorly accessibly installed field device through a relay, with the field device in the vicinity of the field device without having to go through the system controller. This is necessary, for example, during maintenance and inspections. Such an arrangement is known, for example, from International Patent Publication No. WO 2020/114719 A1.

During maintenance, it must be ensured that a valve reaches and maintains a switching state necessary for the work as long as the work is in progress. Unintentional switching must be avoided.

### SUMMARY

Therefore, an object of the invention is to create a valve control device that allows safe maintenance of the valve.

This object is achieved by a valve control device according to embodiments described herein.

Initially, the valve control device includes at least one switching stage, control electronics for controlling the switching stage, and a BUS interface for communicating with a higher-level system controller of a processing plant. In this context, BUS comprises the common automation technology bus systems in plant engineering including parallel wiring, in which the individual devices are connected directly to the system controller.

In this valve control device, a near-field communication interface is now provided, and the control electronics are configured to give a control command coming in through the near-field communication interface priority for controlling the switching stage. Priority means that the control electronics are in an operating state in which only a command coming in through the near-field communication interface is used to effectively control the switching stage. A command coming in simultaneously from the system controller through the bus interface is not used in this operating state. This is regardless of whether a response, for example, of the switching state of the valve, to the system controller takes place at the same time. The command coming in from the system controller can still be signaled to the operator as an indicator through the access device.

For a method for operating an arrangement with a valve control device, which comprises a first near-field communication interface and a bus interface, and an access device with a second near-field communication interface, it is proposed that, in one step, a near-field connection is established between the first near-field communication interface and the second near-field communication interface. In another step, a control command is sent over the near-field connection. An additional step includes that this control command is given priority over a command received by the valve control device through the bus interface.

The drive can be electric. The switching stage then comprises an electronic switching means such as a thyristor in order to switch the supply of electricity to a power part, for example, an electric motor.

The drive can be hydraulic or pneumatic. The switching stage then comprises at least one pilot valve, with which the supply of hydraulic medium or pneumatic medium to the drive is switched. In this embodiment, a valve control device comprising a pilot valve, control electronics for controlling the pilot valve, and a bus interface for communicating with a system controller of a processing plant is provided. To achieve the object, a near-field communication interface is provided in the valve control device, and the control electronics are configured to give a control command coming in through the near-field communication interface priority for controlling the pilot valve.

Setting up the valve control device for this functionality can comprise a selector in the valve control device. A control command coming in through the near-field communication interface can be selected for execution by the selector. The selector can be designed as a switching circuit or as in a software routine, which software routine can be executed by means of a microprocessor provided in the valve control device. The selector can be designed as part of the control electronics or as an independent module.

In this way, it is ensured that the operator on site has the switching state of the valve completely under control. Switching by the system controller is suppressed at this point in time.

In one arrangement, which comprises a valve control device and an access device, the near-field communication interface of the valve control device can be connected to a near-field communication interface of an access device. The access device can be connected mechanically and releasably to the valve control device. For the mechanical connection, a coupling can be provided, which is based, for example, on a magnetic operating principle or designed as a suction cup.

The aforementioned method is advantageously expanded by a method step in which a mechanical connection is established between the valve control device and the access device. This ensures that the right devices are coupled to each other, and the data coupling is secured by mechanical coupling.

This advantage is even greater if, according to one development, near-field communication is established between the first and the second near-field communication interface when the mechanical connection exists.

Preferably, the access device has a display field and at least one button for operation. Data can be exchanged over the wireless data connection of the near-field communication interfaces, for example control commands for changing the valve position, measurement data, and state data, for example, valve position. Control command also includes a command with which a sensor calibration is started, also called “teach-in.” The data can also be suitable for parameterizing or configuring the valve control device. The data can be a firmware update, for example. State data collected in the valve control device over a period of time can also be called up through near-field communication.

Because the control electronics use control commands that come in through the near-field communication interface to bring about a desired valve position, the access device functions as an operating unit to set the valve position independently of the system controller. This is very helpful during maintenance because the service technician can set the state directly at the valve without requiring interaction with the system controller.

The access device can be configured to execute a password query, with which it is secured against unauthorized use. This password query can be brought about by the system controller through the bus, the bus interfaces, and the near-field communication interfaces that are connected to each other.

The access device can lock the valve control device with respect to the system controller. This makes maintenance, for example, safer. To achieve this, the control electronics are configured to block control commands of the system controller, which can be sent through the bus interface, in accordance with a blocking command coming in through the near-field communication interface.

The access device can have, in addition to operating elements and the near-field communication interface, at least one far-field communication interface operating on the basis of, for example, Wi-Fi or wireless local-area network (WLAN). Through the far-field communication interface, communication with a server that is triggered, for example, by the operator, can take place over the internet. A connection to a mobile operating device can be created. This mobile operating device, for example a tablet or a mobile phone, can send control commands to the valve device through the access device. The commands control the at least one pilot valve and, through this, the drive.

The valve control device can have a display element, for example, a light-emitting diode, with which a data transmission through the near-field communication interface is displayed.

It is advantageous to equip the valve control device with a manual control element, which allows an operator to actuate the pilot valve or the pilot valves for controlling the drive by hand independently of and with priority over control commands originating from the system controller or access device. The hierarchy of the control commands that results provides the greatest safety during maintenance around and on the valve. The manual control element has the highest priority, followed by the access device, which has a higher priority than the system controller.

### BRIEF DESCRIPTION OF THE DRAWINGS

The invention will be described, and the advantages thereof explained in more detail, based on an example embodiment and its development.

FIG. 1 is a schematic representation of an arrangement with a valve control device.

FIG. 2 is a schematic representation of several assemblies in the access device and valve control device.

### DETAILED DESCRIPTION

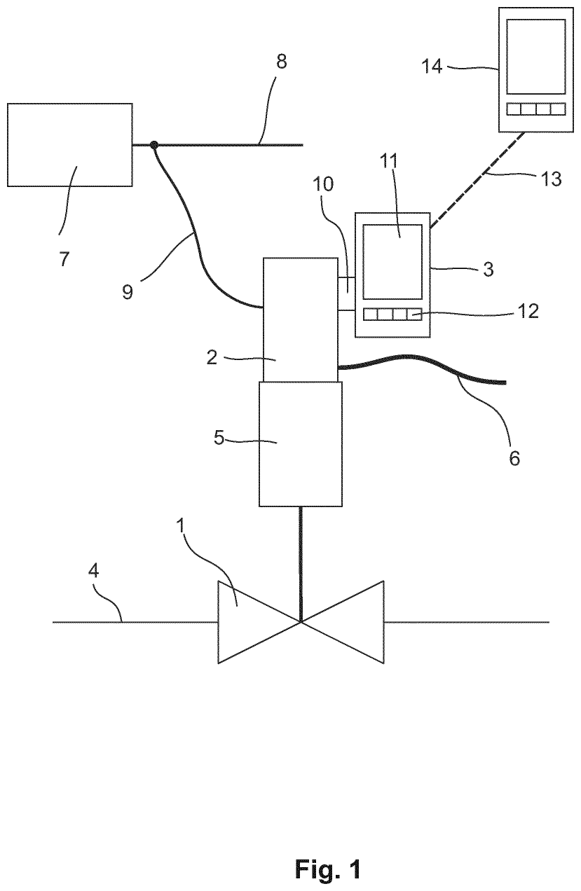

FIG. 1 schematically shows an arrangement with a valve 1, a valve control device 2, and an access device 3. The valve 1 can be a shut-off valve used in a line 4 of a processing plant, in particular in the industrial fields mentioned at the beginning (e.g., food products, beverages, medicines, fine chemical products, biotechnology, and the like). It can also be a regulating valve, a double-seated valve, a switching valve, or the like, as long as the valve type is used in this area of application.

A drive 5 is arranged between the valve 1 and the valve control device 2. The drive 5 is designed in this embodiment to be driven by a pressure medium, particularly pneumatically. The drive 5 brings about a change in position of a closure body (not shown in the diagram) of the valve 1, so that a switching state of the valve 1 changes. In particular, the valve 1 can block the flow of fluid through the line 4 in a closed position or allow it in an open position.

The drive 5 is activated by the valve control device 2. In the case of a pneumatic drive, this is done by compressed air. The compressed air is introduced into the drive 5 to move a piston there, which is operatively connected to the closure body in the valve 1. The compressed air is taken from a pressure medium feed line 6.

For normal operation, the valve control device 2 is connected to a system controller 7. This connection can be implemented by a processing plant bus 8, to which the valve control device 2 is connected with a bus connection 9 for exchanging data. Often, the bus 8 and bus connection 9 are wired. The data exchange comprises in particular control commands, which are converted into a change of the switching state of the valve 1 by the valve control device 2. Another part of the data can be, for example, the report of the current switching state.

The access device 3 is coupled mechanically and releasably to the valve control device 2. For this purpose, a mechanical coupling 10 is provided. The mechanical coupling 10 can be based, for example, on a magnetic operating principle or can be designed as a suction cup. The mechanical coupling 10 can comprise parts on the valve control device 2 and the access device 3. Alternatively, for example in the embodiment with a suction cup, the mechanical coupling 10 can be arranged completely on the valve control device 2 or on the access device 3.

The access device 3 has operating and display elements, for example, a display field 11 and at least one button 12. The operating and display elements are adapted to the data and control commands to be processed and displayed on the access device 3 as well as to the application environment, for example, a hygienic and clean set-up area. A touchscreen is also conceivable.

The access device 3 can be designed such that it can be connected to a mobile operating device 14 for a data transfer 13. The mobile operating device 14 can be a tablet, a smartphone, a laptop, or the like.

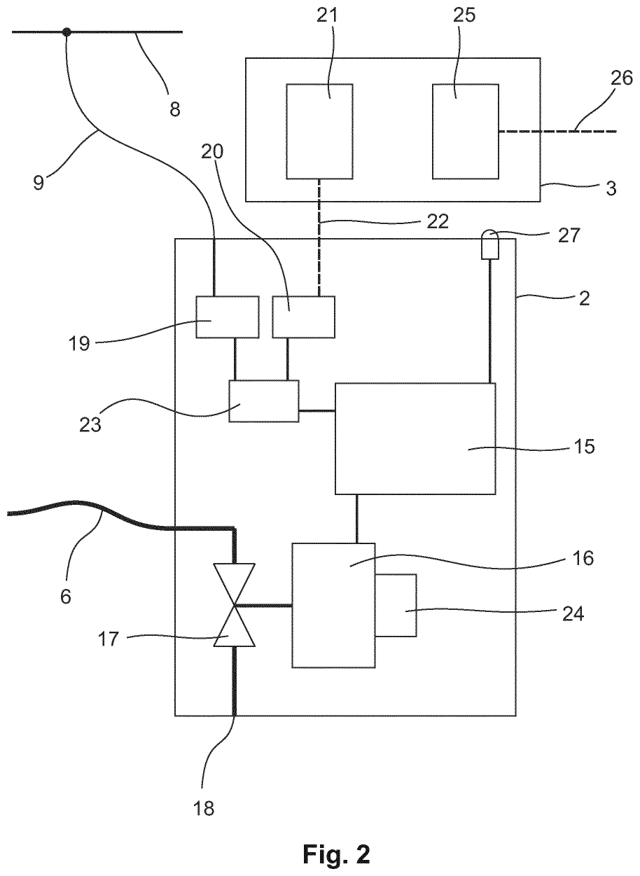

FIG. 2 schematically shows functional assemblies of the valve control device 2 and of the access device 3.

The core of the valve control device 2 is control electronics 15. The control electronics 15 work together with a driver 16. The switching position of a pilot valve 17 can be changed between open and closed using the driver 16. In this embodiment, the pilot valve 17 assumes the function of a switching stage. The switching position of the pilot valve 17 determines whether pressure medium from the pressure medium feed line 6 reaches the pressure medium outlet 18, which is fluidically connected to the drive 5. The driver 16 can be designed, for example, on an electromagnetic basis.

The pilot valve 17 is controlled in accordance with control commands from the system controller 7. These control commands are transmitted to the valve control device 2 through the bus 8. The bus connection 9 is operatively connected to a bus interface 19 in the valve control device 2. The bus interface 19 transmits the control commands to the control electronics 15, in an adapted form if necessary.

The valve control device 2 has, in addition to the bus interface 19, a first near-field communication interface 20.

A second near-field communication interface 21 is provided in the access device 3.

A near-field connection 22 for transmitting data, in particular setting commands, can be established between the first near-field communication interface 20 and the second near-field communication interface 21. An advantage of the near-field connection 22 is that it constitutes secure communication between the valve control device 2 and the access device 3. In this case, the two devices, which are brought into contact with each other through the action of the mechanical coupling 10, for example, communicate with each other in a targeted manner. This prevents influence from third-party devices, for example, the valve control devices of adjacent valves. The near-field communication makes influence from adjacent devices largely impossible.

A selector 23 in operative connection with the bus interface 19 and the first near-field communication interface 21 is provided in the valve control device. The selector 23 can be an independent assembly based, for example, on logic units. Alternatively, it can be part of the control electronics 15. Regardless of the position, the selector 23 can also be designed as software.

The selector 23 is configured to transmit a control command for changing the switching position of the valve 1, which brings about an activation of the pilot valve 17, to the control electronics 15 for execution according to a defined order of priority. If similar control commands come in simultaneously or temporally adjacently through the bus interface 19 and the first near-field communication interface 20, only the one that comes in through the first near-field communication interface 20 is passed on to the control electronics 15 for processing. This makes the valve 1 safely switchable for an operator in the immediate spatial vicinity of the valve 1.

It is advantageous to provide a manual control element 24, with which the pilot valve 17 can be switched by hand by the operator. This manual control element 24 actuates the pilot valve 17 independently of setting commands that come in from the control electronics 15. This means the manual control element 24 has the highest priority. Preferably, the manual control element 24 is only accessible to the operator when a housing of the valve control device 2 is opened. If multiple pilot valves 17 are present, multiple manual control elements 24 can be provided, wherein each one is assigned to a respective pilot valve 17.

In addition to controlling the pilot valve 17, the access device 3 can be designed to execute additional functions that can be implemented in conjunction with the correspondingly designed valve control device 2.

For example, error and diagnostic data can be read out and displayed from an error memory provided in the valve control device 2. The stroke can be set, and tolerances of the position values of the valve closure member can be read out and set. The access device 3 can function as a data logger.

The access device 3 can comprise a far-field communication interface 25, with which a far-field connection 26 to another device, for example the mobile operating device 14, can be established. The far-field connection 26 can be based on a WLAN or Wi-Fi standard. Over the far-field connection 26, data can be exchanged with devices on the internet, for example, a transmission of error logs and parameters that allow and cause replacement parts to be ordered.

The valve control device can have a display element 27 that sends signals, for example optical signals, that are visible for the operator. The display element 27 can be used, for example, to display an active data transmission over the near-field connection 22. In a cost-effective design, the display element 27 comprises a light-emitting diode.

The arrangement explained based on FIG. 1 and FIG. 2 with a valve control device 2 and an access device 3 is preferably operated with a method that, at its core, comprises the following steps. Namely, a near-field connection 22 is established between the first near-field communication interface 20 on the valve control device 2 and the second near-field communication interface 21 on the access device 3, a control command is sent over the near-field connection 22, and the control command is given priority over a command received by the valve control device 2 through the bus interface 19.

Using this method, an operator of the arrangement who, for example, wishes to perform maintenance, can set the switching state of the valve 1 in a suitable way by using an access device 3. In doing so, it is advantageously avoided for the duration of the near-field connection 22 that the switching state is changed unintentionally by the operator through the bus interface 19. This increases safety for the operator.

To bring a specific valve control device 2 into the state desired by the operator and keep it safely in this state, an additional step that a mechanical connection is established between the valve control device 2 and the access device 3 can be performed.

Safety is further increased when the method also comprises that a near-field connection 22 is established between the first near-field communication interface 20 and the second near-field communication interface 21 when the mechanical connection exists.

The following is a list of reference signs used in this specification and in the drawings.
1 Valve
2 Valve control device
3 Access device
4 Line
5 Drive
6 Pressure medium feed line
7 System controller
8 Bus
9 Bus connection
10 Mechanical coupling
11 Display field
12 Button
13 Data transfer
14 Mobile operating device
15 Control electronics
16 Driver
17 Pilot valve
18 Pressure medium outlet
19 Bus interface
20 First near-field communication interface
21 Second near-field communication interface
22 Near-field connection
23 Selector
24 Manual control element
25 Far-field communication interface
26 Far-field connection
27 Display element

1. A valve control device, comprising:
a switching stage;
control electronics for controlling the switching stage; and
a bus interface for communicating with a system controller of a processing plant, wherein a near-field communication interface is provided in the valve control device, and the control electronics are configured to give priority to a control command coming in through the near-field communication interface for controlling the switching stage.

2. The valve control device according to claim 1, comprising:
a selector that transmits control commands that come in through the near-field communication interface to the control electronics with priority over the bus interface.

3. The valve control device according to claim 1, wherein the control electronics are configured to block control commands of the system controller, which can be sent through the bus interface, in accordance with a blocking command coming in through the near-field communication interface.

4. The valve control device according to claim 1, wherein the switching stage comprises a pilot valve.

5. The valve control device according to claim 4, comprising:
a manual control element that can control the pilot valve to correspond with the control electronics.

6. An arrangement with a valve control device according to claim 1 and an access device, wherein the access device comprises a second near-field communication interface and can be mechanically connected to the valve control device.

7. The arrangement according to claim 6, wherein the access device has a far-field communication interface.

8. A method for operating an arrangement with a valve control device comprising a first near-field communication interface and a bus interface, and an access device with a second near-field communication interface, the method comprising:
establishing a near-field connection between the first near-field communication interface and the second near-field communication interface;
sending a control command over the near-field connection; and
prioritizing the control command over a command received by the valve control device through the bus interface.

9. The method according to claim 8, comprising:
establishing a mechanical connection is-established-between the valve control device and the access device.

10. The method according to claim 9, comprising:
establishing a near-field connection between the first near-field communication interface and the second near-field communication interface when the mechanical connection exists.

11. The valve control device according to claim 2, wherein the switching stage comprises a pilot valve.

12. The valve control device according to claim 11, comprising:
a manual control element that can control the pilot valve to correspond with the control electronics.

13. The valve control device according to claim 3, wherein the switching stage comprises a pilot valve.

14. The valve control device according to claim 13, comprising:
a manual control element that can control the pilot valve to correspond with the control electronics.

15. An arrangement with a valve control device according to claim 2 and an access device, wherein the access device comprises a second near-field communication interface and can be mechanically connected to the valve control device.

16. The arrangement according to claim 15, wherein the access device has a far-field communication interface.

17. An arrangement with a valve control device according to claim 3 and an access device, wherein the access device comprises a second near-field communication interface and can be mechanically connected to the valve control device.

18. The arrangement according to claim 17, wherein the access device has a far-field communication interface.

19. An arrangement with a valve control device according to claim 4 and an access device, wherein the access device comprises a second near-field communication interface and can be mechanically connected to the valve control device.

20. The arrangement according to claim 19, wherein the access device has a far-field communication interface.
